(19) United States
(12) Patent Application Publication
(10) Pub. No.: US 2011/0289905 A1
(43) Pub. Date: Dec. 1, 2011

(54) EXHAUST GAS HEAT RECOVERY HEAT EXCHANGER

(75) Inventors: JAMES A. ACRE, BARKER, NY (US); JAMES A. BRIGHT, GASPORT, NY (US); JAMES J. KOO, E. AMHERST, NY (US); MARK J. ZIMA, CLARENCE CENTER, NY (US)

(73) Assignee: DELPHI TECHNOLOGIES, INC., TROY, MI (US)

(21) Appl. No.: 13/118,906

(22) Filed: May 31, 2011

Related U.S. Application Data
(60) Provisional application No. 61/350,157, filed on Jun. 1, 2010.

(51) Int. Cl. F01N 5/02; C09K 5/10; B60H 1/00

(52) U.S. Cl. 60/320; 165/41; 165/104.31

(57) ABSTRACT

An exhaust gas heat recovery (EGHR) heat exchanger for an internal combustion engine having a housing, a cylindrical body disposed within the housing, an annular exhaust gas passageway, and a central exhaust gas passageway. The EGHR heat exchanger also includes a bypass valve disposed within the central passageway and adapted to selectively by-pass a portion of the exhaust gas from the central exhaust gas passageway to the annular passageway, and at least one twisted tube having at least one edge coiled within the annular exhaust gas passageway.

### CROSS-REFERENCE TO RELATED APPLICATION

This application claims the benefit of U.S. Provisional Patent Application Ser. No. 61/350,157 for an EXHAUST GAS HEAT RECOVERY EXCHANGER, filed on Jun. 1, 2010, which is hereby incorporated by reference in its entirety.

### TECHNICAL FIELD OF INVENTION

The present disclosure relates to a heat exchanger for a motor vehicle; more particularly, to a heat exchanger for recovering heat from the exhaust of an internal combustion engine of the motor vehicle.

### BACKGROUND OF INVENTION

A heater core, which is located inside a heating, ventilating, and air conditioning (HVAC) module of a motor vehicle supplies thermal energy to the passenger compartment for comfort heating. The heater core is typically a liquid-to-air heat exchanger, in which the liquid is hot coolant from an internal combustion engine. With the advent of greater efficiency internal combustion engines and hybrid vehicles having smaller internal combustion engines, the amount of thermal engine available to provide comfort to passengers in the passenger compartment may not be adequate.

Exhaust gas heat exchangers are known to be used to capture waste heat from the exhaust gas of an internal combustion engine to supplement the heat provided by the heater core to heat the ambient air directed to the passenger compartment. Aside from providing supplementary heat to the passenger compartment, the heat energy in the exhaust gas can be used to heat other fluids within the vehicle, such as the windshield wiper fluid, motor oil, transmission fluid, and engine coolant.

More efficient and smaller internal combustion engines produce less waste heat for the exhaust gas heat exchangers to recover. Accordingly, there is a need to extract as much waste heat as possible from the exhaust gases of efficient and smaller internal combustion engines to supplement comfort heating and to heat the vehicle fluids as mentioned above. There is also a need to control the amount of heat extracted from the hot exhaust gases.

### SUMMARY OF THE INVENTION

The invention relates to an exhaust gas heat recovery (EGHR) heat exchanger having a housing disposed along a longitudinal axis, wherein the housing includes a first end cap, a second end cap spaced from the first end cap, and an interior surface therebetween defining a cavity. A cylindrical body is disposed within the cavity defining an annular exhaust gas passageway and a central exhaust gas passageway. At least one tube is coiled about a longitudinal axis disposed within the annular exhaust gas passageway. A second coiled tube may be disposed within the cavity and counter coiled relative to the first coiled tube.

The coiled tubes may be formed of a fluid tube having a non-circular cross-sectional area with at least one edge extending along a local axis. The fluid tube may be twisted about a local axis defining a twisted fluid passageway. A bypass control valve may be disposed in the internal passageway to bypass hot exhaust gas flow from the internal passageway to the annular passageway to control and maximize heat transfer efficiency.

Twisted fluid tubes enhance the turbulence of the exhaust gas side and fluid side, and increase the heat transfer rate (coefficient) between the exhaust gas and fluid sides. For the same flow area, twisted fluid tubes yield smaller hydraulic diameter and provide more heat transfer surface than smooth round tubes, which improves the hear transfer coefficient.

### BRIEF DESCRIPTION OF DRAWINGS

This invention will be further described with reference to the accompanying drawings in which:

FIG. 1 shows a perspective view of an exhaust gas heat recovery (EGHR) heat exchanger.

FIG. 2 shows a cut-away view of the embodiment of the EGHR heat exchanger shown in FIG. 1 extending along a longitudinal axis.

FIG. 3 shows a fluid tube extending along a tube axis.

FIG. 3A shows an end view of the fluid tube of FIG. 3 having a square cross-section.

FIG. 3B shows an end view of an alternative embodiment of the fluid tube having a cross-section that includes 1 edge.

FIG. 4 shows the fluid tube of FIG. 3 twisted along the tube local axis.

FIG. 5 shows a phantom side view of the EGHR heat exchanger of FIG. 1 having the twisted fluid tube of FIG. 4 coiled about the longitudinal axis.

FIG. 6 shows a cross-sectional view of the EGHR heat exchanger of FIG. 5 having dual coils of the twisted fluid tube of FIG. 4.

### DETAILED DESCRIPTION OF INVENTION

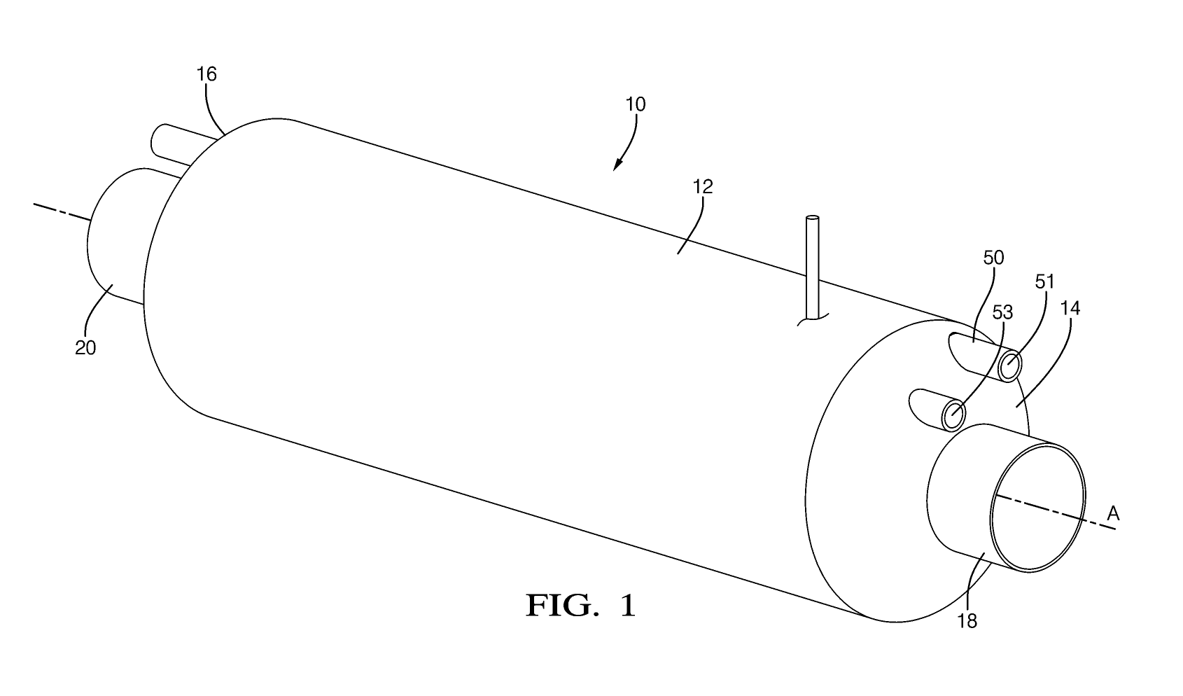

Shown in FIGS. 1 through 6, wherein like numerals indicate corresponding parts throughout the several views, is an embodiment of an exhaust gas heat recovery (EGHR) heat exchanger 10 of the present invention. The EGHR heat exchanger 10 may be used for recovering waste heat from the exhaust gas of an internal combustion engine of a motor vehicle to provide supplementary heat to the passenger compartment as well as to heat automotive fluids, such as the windshield wiper fluid, engine oil, and transmission fluids. For hybrid vehicles, the waste heat from the internal combustion engine may also be recovered to provide heat to the battery compartment to extend the range of the battery life in cold operating conditions.

Shown in FIG. 1 is a perspective view of the EGHR heat exchanger 10. The EGHR heat exchanger 10 includes an elongated housing 12 extending along a longitudinal axis A. The elongated housing 12 includes a first end cap 14 and a second end cap 16 axially spaced from the first end cap 14. Extending from the first end cap 14 is an inlet coupling 18 adapted to hydraulically connect to the exhaust system of a motor vehicle to receive the hot exhaust gas from an internal combustion engine. Extending from the second end cap 16 is an outlet coupling 20 adapted to hydraulically connect to the downstream portion of the exhaust system of the motor vehicle. A fluid tube 50 having a tube inlet 51 and tube outlet 53 defining a passageway for fluid flow is partially disposed within the elongated housing 12. The fluid tube 50 may be formed of any heat conductive material such as copper, stainless steel, brass, or aluminum.

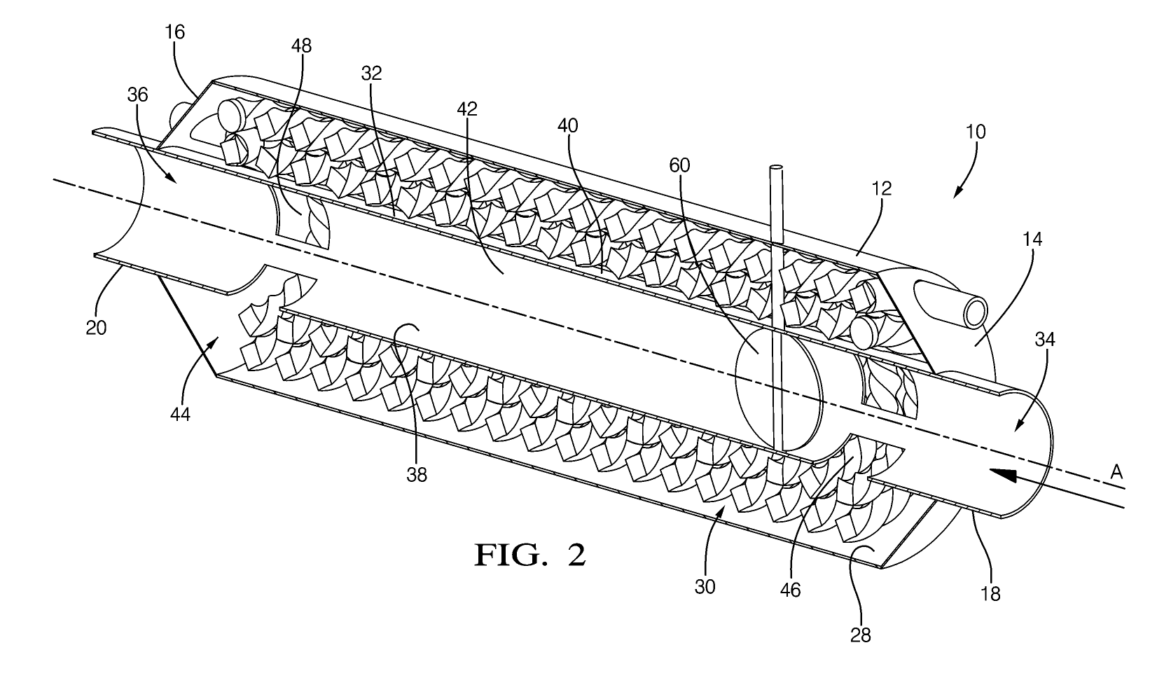

Shown in FIG. 2 is a perspective cut-away view of the EGHR heat exchanger 10 of FIG. 1. The elongated housing 12 includes an interior surface 28 defining an interior cavity 30. Disposed within the interior cavity 30 is a substantially cylindrical body 32 having a cylindrical body first end 34 extending through the first end cap 14 of the elongated housing 12 to define the inlet coupling 18. Similarly, the cylindrical body includes a second end 36 extending through the second end cap 16 of the elongated housing 12 to define the outlet coupling 20. The cylindrical body 32 also includes a cylindrical body interior surface 38 defining a central exhaust gas passageway 42 and a cylindrical body exterior surface 40. The cylindrical body exterior surface 40 is spaced from and cooperates with the interior surface 28 of the elongated housing 12 to define an annular exhaust gas passageway 44.

The cylindrical body defines a first opening 46 adjacent to the cylindrical body first end 34 and a second opening 48 adjacent to the cylindrical body second end 36, in which both first and second openings 46, 48 are within the interior cavity 30 of the elongated housing 12. Disposed within the central exhaust gas passageway 42 between the first opening 46 and second opening 48 is a by-pass valve 60, such as that of a butterfly type valve known for its simple design or the swinging-arm type known for its lower pressure drop as compared to other types of by-pass valves. The by-pass valve 60 may selectively by-pass a portion or all of the hot exhaust gas flow from the central exhaust gas passageway 42 to the annular exhaust gas passageway 44.

As the by-pass valve 60 restricts or closes the flow of hot exhaust gas through the central exhaust gas passageway 42, the hot exhaust gas finds the path of least restriction, which is by exiting the first opening 46 and flows through the annular exhaust gas passageway 44 toward the second opening 48. The exhaust gas then re-enters the central exhaust gas passageway 42 through the second opening 48 and exits the outlet coupling 20. The by-pass valve 60 may be provided through the center of the heat exchanger assembly to minimize the pressure drop of the fluid flow during by-pass operations. The by-pass valve 60 may also be used to control the temperature of the fluid exiting the fluid tube outlet 53 by controlling the amount of hot exhaust gas that is by-passed through the annular exhaust gas passageway 42.

Shown in FIG. 3 is a fluid tube 50 extending along a local tube axis B. Shown in FIG. 3A is the fluid tube 50 of FIG. 3 having a square shaped cross-sectional profile. A square shaped cross-sectional profile provides four distinctive edges 52 running the length of the fluid tube 50. A square shaped cross-sectional profile is shown as a non-limiting exemplary embodiment. Any fluid tube 50 having a cross-sectional profile that includes at least one edge 52 running substantially the length of the fluid tube 50 may be utilized. FIG. 3B shows an example of a cross-sectional profile of an alternative embodiment of the fluid tube 50′ having one edge 52′ extending the length of the tube. Other cross-sectional profile shapes may include a triangle, a hexagon, an octagon, or any polygonal shape having at least one edge.

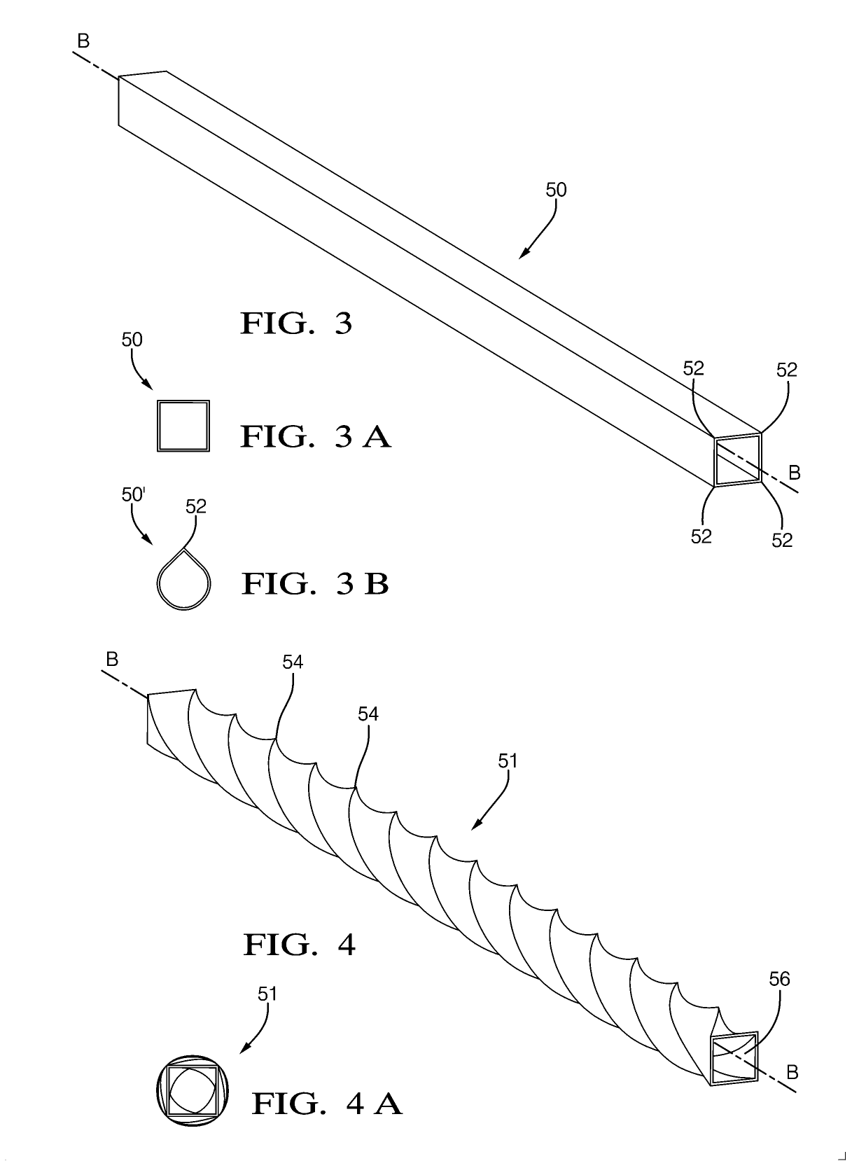

Shown in FIG. 4 is the fluid tube 50 having a square cross-sectional profile twisted about the local axis B forming a twisted tube 51. Shown in FIG. 4 A is an end view of the twisted tube 51. The twisted tube 51 defines a spiraled fluid flow passageway 56 that aids in the mixing of the fluid flowing within passageway 56 by swirling the fluid flow. The edges 52 of the twisted fluid tube 51 defines spiraled edges 54 that interrupt the flow of the hot exhaust gas flow that passes the exterior of the twisted tube 51, thereby creating turbulent flow.

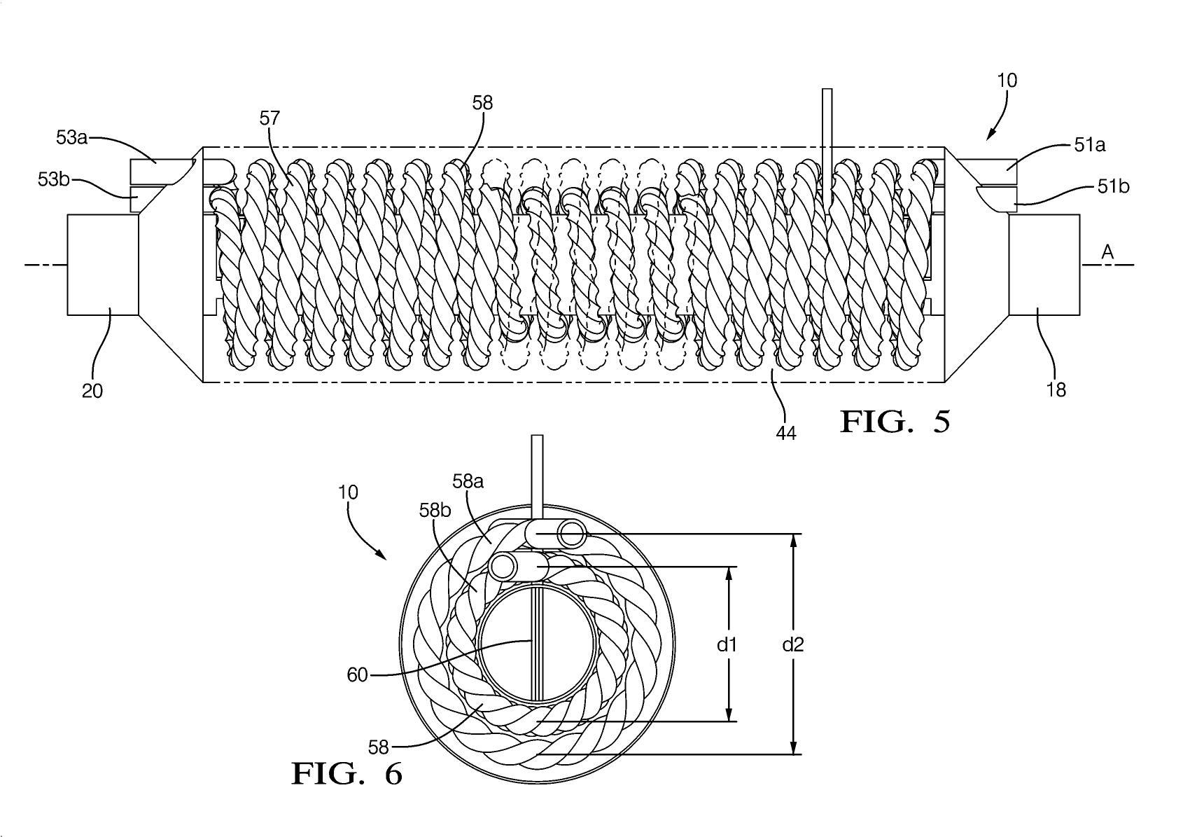

Shown in FIG. 5 is a phantom view of the EGHR heat exchanger 10 showing the twisted tube 51 coiled about the longitudinal axis A within the annular exhaust gas passageway 44. The coiling of the twisted tube 51 increases the surface area available for heat transfer between the hot exhaust gas passing through the annular exhaust gas passage way 44 and the fluid flowing in the fluid flow passageway 56 of the fluid tube 50. The coils 58 are positioned at a predetermined angle with respect to the longitudinal axis.

The EGHR heat exchanger 10 may have multiple internal twisted tubes 51 helically coiled about the longitudinal axis A defining multiple spiraled passageways 56. Shown in FIG. 5 is a first coil 58a coaxially located with a second coil 58b, in which each of the coils 58a, 58b includes a tube inlet 51a, 51b and outlet 53a, 53b. The first coil 58a includes a diameter (d2) that is large than the diameter (d1) of the second coil 58b. Shown in FIG. 6 is an end view of the EGHR heat exchanger 10 having the second coil 58b nested within the first coil 58a within the annular exhaust gas passageway 44. The first and second coils 58a, 58b may be coiled in the same direction where the individual coils 54a, 54b are angled in substantially the same direction with respect to the longitudinal axis. As an alternative embodiment, the first and second coils 58a, 58b may be coiled in the opposite direction with respect to each other where the individual coils are angled in substantially the opposite direction with respect to the longitudinal axis-A as shown in the partial view of FIG. 5. The flow of fluid through the coils 54a, 54b may be co-current or concurrent with respect to the direction of exhaust gas flow, and also may be co-current or concurrent with respect to each other.

The twisted tubes 51 in a coiled configuration within the annular exhaust gas passageway 44 enhance the turbulence of the exhaust gas flow and fluid flow within the twisted tube 51, and increase the heat transfer rate (coefficient) between the exhaust gas and fluid sides. For the same flow area, twisted tubes 51 yield a smaller hydraulic diameter and provide more heat transfer surface than conventional smooth round tubes, thereby improving the heat transfer coefficient. Multiple coils provide the benefit of increased heat transfer area for one fluid or the option of heating multiple fluids at one time.

While this invention has been described in terms of the preferred embodiments thereof, it is not intended to be so limited, but rather only to the extent set forth in the claims that follow. The disclosure is directed toward a exhaust gas heat recovery (EGHR) heat exchangers, but those with ordinary skill in the art would recognized that the disclosure is also applicable to EGR coolers.

Having described the invention, it is claimed:

1. An exhaust gas heat recovery (EGHR) heat exchanger for an internal combustion engine, comprising:
a housing disposed along a longitudinal axis, wherein said housing includes a first end cap, a second end cap axially spaced from said first end cap, and an interior surface therebetween defining a cavity;
a cylindrical body longitudinally disposed within said cavity and includes a first end extending through said first end cap defining an exhaust gas inlet, an opposite second end extending through said second end cap defining an exhaust gas outlet, an exterior surface cooperating with said interior surface of housing to define an annular exhaust gas passageway, and an interior surface defining a central exhaust gas passageway;
means for selectively by-passing a portion of the exhaust gas from the central exhaust gas passageway to the annular passageway; and
at least one fluid tube disposed within said annular exhaust gas passageway and coiled about the longitudinal axis defining a first coil.

2. The EGHR heat exchanger of claim 1, wherein said fluid tube includes a polygon shaped cross-sectional area.

3. The EGHR heat exchanger of claim 2, wherein said fluid tube is twisted about a local axis.

4. The EGHR heat exchanger of claim 1, wherein said fluid tube includes a cross-sectional area having at least one edge twisted about a local axis

5. The EGHR heat exchanger of claim 4, wherein said fluid tube includes a square shaped cross-sectional area having 4 edges twisted about said local axis.

6. The EGHR heat exchanger of claim 5, further comprising a second coil disposed in said annular exhaust gas passageway.

7. The EGHR heat exchanger of claim 6, wherein said first coil is coiled in a first direction and said second coil is coiled in a second direction opposite of that of said first direction.

8. The EGHR heat exchanger of claim 6, wherein said first coil is slanted in a first direction and said second coil is slanted in a second direction opposite that of said first coil with respect to the longitudinal axis.

9. The EGHR heat exchanger of claim 4, wherein means for selectively by-passing a portion of the exhaust gas from the central exhaust gas passageway to the annular passageway includes:
said cylindrical body defining a first opening adjacent to said first end of cylindrical body and a second opening adjacent to said second end of cylindrical body, wherein said first and second openings are located within said cavity of housing.

10. The EGHR heat exchanger of claim 9, wherein means for selectively by-passing a portion of the exhaust gas from the central exhaust gas passageway to the annular passageway further includes a by-pass valve disposed within said central exhaust gas passageway between said first opening and said second opening of cylindrical body.

11. An exhaust gas heat recovery (EGHR) heat exchanger for an internal combustion engine, comprising:
a housing disposed along a longitudinal axis, wherein said housing includes a first end cap, a second end cap axially spaced from said first end cap, and an interior surface therebetween defining a cavity;
a cylindrical body longitudinally disposed within said cavity and includes a first end extending through said first end cap defining an exhaust gas inlet, an opposite second end extending through said second end cap defining an exhaust gas outlet, an exterior surface cooperating with said interior surface of housing to define an annular exhaust gas passageway, and an interior surface defining a central exhaust gas passageway;
at least one fluid tube disposed within said annular exhaust gas passageway and coiled about the longitudinal axis defining a first coil;
said cylindrical body defines a first opening adjacent to said first end of cylindrical body and a second opening adjacent to said second end of cylindrical body, wherein said first and second openings are located within said cavity of housing;
a throttle valve disposed within said central exhaust gas passageway between said first and second openings of said cylindrical body and adapted to selectively obstruct a portion of the exhaust gas flowing in said central exhaust gas passageway, thereby causing the portion of exhaust gas to flow through said annular passageway.

12. The EGHR heat exchanger of claim 11, wherein said fluid tube includes a cross-sectional area having at least one edge twisted about a local axis

13. The EGHR heat exchanger of claim 12, wherein said fluid tube includes a square shaped cross-sectional area having 4 edges twisted about said local axis.

14. The EGHR heat exchanger of claim 13, further comprising a second coil disposed in said annular exhaust gas passageway.

15. The EGHR heat exchanger of claim 14, wherein said first coil is coiled in a first direction and said second coil is coiled in a second direction opposite of that of said first direction.

16. The EGHR heat exchanger of claim 15, wherein said first coil is slanted in a first direction and said second coil is slanted in a second direction opposite that of said first coil with respect to the longitudinal axis.
